(19) United States
(12) Patent Application Publication
(10) Pub. No.: US 2023/0376761 A1
(43) Pub. Date: Nov. 23, 2023

(54) TECHNIQUES FOR ASSESSING UNCERTAINTY OF A PREDICTIVE MODEL

(71) Applicant: NETFLIX, INC., Los Gatos, CA (US)

(72) Inventors: James Edward MCINERNEY, San Jose, CA (US); Nathan KALLUS, New York, NY (US)

(21) Appl. No.: 18/319,146

(22) Filed: May 17, 2023

Related U.S. Application Data
(60) Provisional application No. 63/343,489, filed on May 18, 2022.

(51) Int. Cl. G06N 3/08

(52) U.S. Cl. CPC G06N 3/08

(57) ABSTRACT

One or more embodiments include a computer-implemented method that includes receiving a data set generated by a machine learning model, wherein the data set comprises a plurality of data samples that are independent of each other, performing two or more fitting operations to fit the data set to a regularized maximum likelihood estimators (MLEs), determining a variance associated with the data set based on a derivative associated with the regularized MLEs, and performing one or more operations associated with the machine learning model based on the variance.

### CROSS-REFERENCE TO RELATED APPLICATIONS

This application claims priority benefit of the United States Provisional Patent Application titled, “TECHNIQUES FOR ASSESSING UNCERTAINTY OF A PREDICTIVE MODEL,” filed on May 18, 2022 and having Ser. No. 63/343,489. The subject matter of this related application is hereby incorporated herein by reference.

### BACKGROUND OF THE INVENTION

### Field of the Invention

Embodiments of the present invention relate generally to computer networks and, more specifically, to techniques for assessing uncertainty of a predictive model.

### Description of the Related Art

Using machine learning, computer systems can make decisions based on the predictions of large-scale models trained on massive datasets. These predictions are used for various real-world applications. For example, the predictions may be used in a content delivery system to identify content items from a catalogue that should be presented to a given user.

Trained machine learning models are subject to uncertainty due to randomness (aleatoric uncertainty) or lack of knowledge (epistemic uncertainty). Epistemic uncertainty quantification is a crucial aspect of drawing credible conclusions from predictive models. Variance is a measure of such uncertainty allowing for the computation of confidence intervals and standard errors.

Prior art techniques for assessing uncertainty in predictive models include the delta method and the bootstrap sampling method. The main objects of the delta method are estimators, which are functions of collected data used to determine the value of an unknown parameter. Typically, the method of maximum likelihood is used to derive such an estimator. Given maximum likelihood estimates [symbol] and a function satisfying certain regularity conditions, the delta method then estimates the variance of ψ( [symbol] ) using the knowledge of the variance of [symbol] .

For more complex machine learning models where the delta method cannot be applied, the bootstrap sampling method is used. This method involves repeatedly drawing samples of data, called bootstrap samples, with replacement from the original sample. The statistic or estimator of interest is evaluated for each bootstrap sample and is used to construct a sample distribution from which further statistical inferences can be made.

One drawback of the delta method and the bootstrap sampling method is the computational complexity of executing those methods. In particular, when the machine learning model consists of a large number of parameters, the computational requirements needed to execute the delta method are prohibitive. Additionally, the bootstrap method requires the estimator to be applied repeatedly, which may be computationally infeasible, especially when the estimator comprises a model-fitting algorithm and prediction.

As the foregoing illustrates, what is needed in the art is a computationally efficient method for uncertainty quantification for large predictive models.

### SUMMARY

One or more embodiments include a computer-implemented method that includes receiving a data set generated by a machine learning model, wherein the data set comprises a plurality of data samples that are independent of each other, performing two or more fitting operations to fit the data set to a regularized maximum likelihood estimates (MLEs), determining a variance associated with the data set based on a derivative associated with the regularized MLEs, and performing one or more operations associated with the machine learning model based on the variance.

At least one technological advantage of the disclosed techniques relative to the prior art is that the variance of a data set can be computed in a computationally efficient manner relative to prior art techniques. This cost saving enables variance to be computed in deep learning and other machine learning domains, where the variance computation would otherwise be prohibitive. These technical advantages provide one or more technological improvements over prior art approaches.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a network infrastructure configured to implement one or more aspects of the various embodiments.

FIG. 2 is a block diagram of a content server (e.g., 110) that may be implemented in conjunction with the network infrastructure of FIG. 1, according to various embodiments.

FIG. 3 is a block diagram of a control server (e.g., 120) that may be implemented in conjunction with the network infrastructure of FIG. 1, according to various embodiments.

FIG. 4 is a block diagram of an endpoint device (e.g., 115) that may be implemented in conjunction with the network infrastructure of FIG. 1, according to various embodiments.

FIG. 5 is a block diagram of the data analysis server (e.g., 140) that may be implemented in conjunction with the network infrastructure of FIG. 1, according to various embodiments.

FIG. 6 is a more detailed illustration of the variance computation module (e.g., 526) of FIG. 5, according to various embodiments.

FIG. 7 is a flow diagram of method steps for determining content recommendations using the variance computation module from FIG. 5, according to various embodiments.

### DETAILED DESCRIPTION

In the following description, numerous specific details are set forth to provide a more thorough understanding of the present invention. However, it will be apparent to one of skill in the art that the present invention may be practiced without one or more of these specific details.

### System Overview

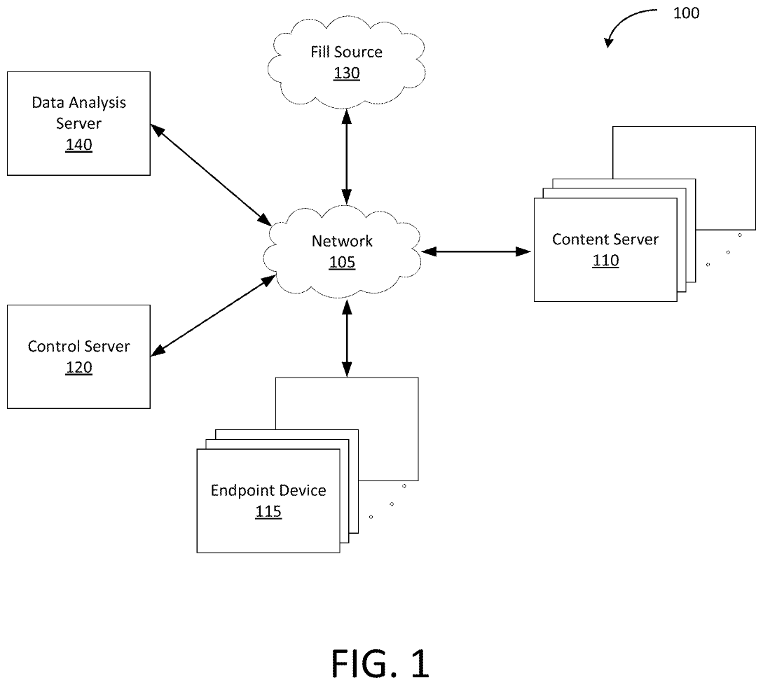

FIG. 1 illustrates a network infrastructure configured to implement one or more aspects of the various embodiments. As shown, network infrastructure 100 includes one or more content servers 110, a control server 120, a data analysis server 140, and one or more endpoint devices 115, which are connected to one another and/or one or more fill source(s) 130 via a communications network 105. Network infrastructure 100 is generally used to distribute content to content servers 110 and endpoint devices 115.

Each endpoint device 115 communicates with one or more content servers 110 (also referred to as “caches” or “nodes”) via network 105 to download content, such as textual data, graphical data, audio data, video data, and other types of data. The downloadable content, also referred to herein as a “file,” is then presented to a user of one or more endpoint devices 115. In various embodiments, endpoint devices 115 may include computer systems, set top boxes, mobile computer, smartphones, tablets, console and handheld video game systems, digital video recorders (DVRs), DVD players, connected digital TVs, dedicated media streaming devices, (e.g., the Roku® set-top box), and/or any other technically feasible computing platform that has network connectivity and is capable of presenting content, such as text, images, video, and/or audio content, to a user.

Network 105 includes any technically feasible wired, optical, wireless, or hybrid network that transmits data between or among content servers 110, control server 120, endpoint device 115, fill source(s) 130, and/or other components. For example, network 105 could include a wide area network (WAN), local area network (LAN), personal area network (PAN), WiFi network, cellular network, Ethernet network, Bluetooth network, universal serial bus (USB) network, satellite network, and/or the Internet.

Each content server 110 may include one or more applications configured to communicate with control server 120 to determine the location and availability of various files that are tracked and managed by control server 120. Each content server 110 may further communicate with fill source(s) 130 and one or more other content servers 110 to “fill” each content server 110 with copies of various files. In addition, content servers 110 may respond to requests for files received from endpoint devices 115. The files may then be distributed from content server 110 or via a broader content distribution network. In some embodiments, content servers 110 may require users to authenticate (e.g., using a username and password) before accessing files stored on content servers 110. Although only a single control server 120 is shown in FIG. 1, in various embodiments multiple control servers 120 may be implemented to track and manage files.

The data analysis server 140 analyzes sets of data generated by the control server 120, the content servers 110, or other data generation sources and generates one or more action recommendations. In various embodiments, the data analysis server 140 computes an uncertainty metric that is associated with a given data set and that measures the uncertainty of the data generation source (e.g., a neural network used to generate the data set).

In various embodiments, fill source(s) 130 may include an online storage service (e.g., Amazon® Simple Storage Service, Google® Cloud Storage, etc.) in which a catalog of files, including thousands or millions of files, is stored and accessed in order to fill content servers 110. Fill source(s) 130 also may provide compute or other processing services. Although only a single instance of fill source(s) 130 is shown in FIG. 1, in various embodiments multiple fill source(s) 130 and/or cloud service instances may be implemented.

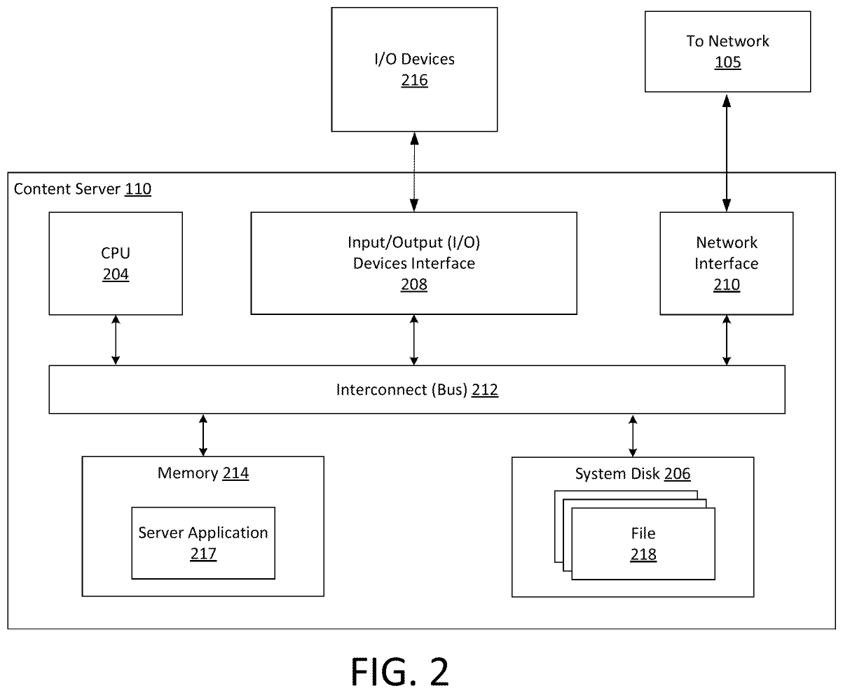

FIG. 2 is a block diagram of content server 110 that may be implemented in conjunction with the network infrastructure of FIG. 1, according to various embodiments. As shown, content server 110 includes, without limitation, a central processing unit (CPU) 204, a system disk 206, an input/output (I/O) devices interface 208, a network interface 210, an interconnect 212, and a system memory 214.

CPU 204 is configured to retrieve and execute programming instructions, such as a server application 217, stored in system memory 214. Similarly, CPU 204 is configured to store application data (e.g., software libraries) and retrieve application data from system memory 214. Interconnect 212 is configured to facilitate transmission of data, such as programming instructions and application data, between CPU 204, system disk 206, I/O devices interface 208, network interface 210, and system memory 214. I/O devices interface 208 is configured to receive input data from I/O devices 216 and transmit the input data to CPU 204 via interconnect 212. For example, I/O devices 216 may include one or more buttons, a keyboard, a mouse, and/or other input devices. I/O devices interface 208 is further configured to receive output data from CPU 204 via interconnect 212 and transmit the output data to I/O devices 216.

System disk 206 may include one or more hard disk drives, solid state storage devices, or similar storage devices. System disk 206 is configured to store non-volatile data such as files 218 (e.g., audio files, video files, subtitle files, application files, software libraries, etc.). Files 218 can then be retrieved by one or more endpoint devices 115 via network 105. In some embodiments, network interface 210 is configured to operate in compliance with the Ethernet standard.

System memory 214 includes server application 217, which is configured to service requests received from endpoint device 115 and other content servers 110 for one or more files 218. When server application 217 receives a request for a given file 218, server application 217 retrieves the requested file 218 from system disk 206 and transmits file 218 to an endpoint device 115 or a content server 110 via network 105. Files 218 include digital content items such as video files, audio files, and/or still images. In addition, files 218 may include metadata associated with such content items, user/subscriber data, etc. Files 218 that include visual content item metadata and/or user/subscriber data may be employed to facilitate the overall functionality of network infrastructure 100. In alternative embodiments, some or all of files 218 may instead be stored in a control server 120, or in any other technically feasible location within network infrastructure 100.

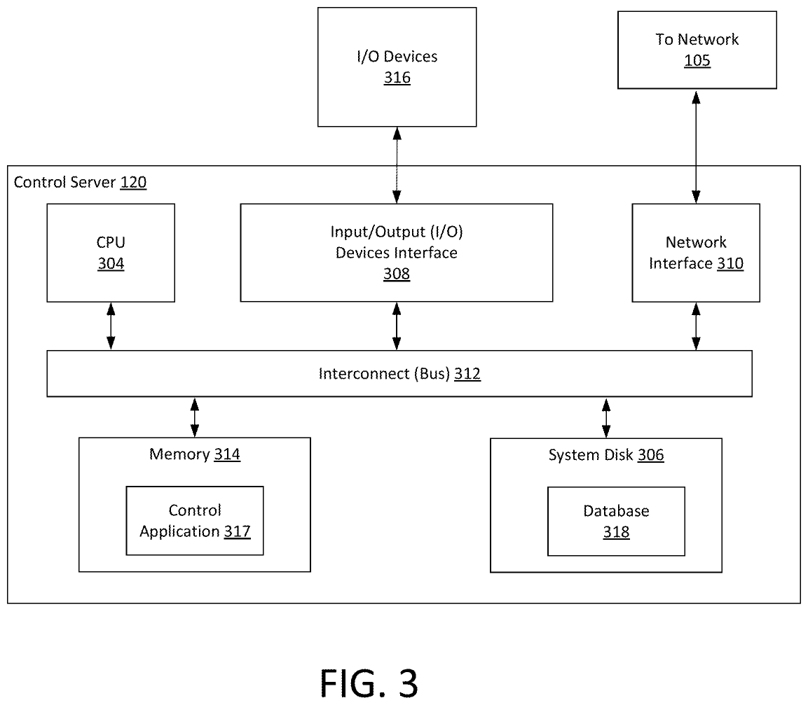

FIG. 3 is a block diagram of control server 120 that may be implemented in conjunction with the network infrastructure 100 of FIG. 1, according to various embodiments. As shown, control server 120 includes, without limitation, a central processing unit (CPU) 304, a system disk 306, an input/output (I/O) devices interface 308, a network interface 310, an interconnect 312, and a system memory 314.

CPU 304 is configured to retrieve and execute programming instructions, such as control application 317, stored in system memory 314. Similarly, CPU 304 is configured to store application data (e.g., software libraries) and retrieve application data from system memory 314 and a database 318 stored in system disk 306. Interconnect 312 is configured to facilitate transmission of data between CPU 304, system disk 306, I/O devices interface 308, network interface 310, and system memory 314. I/O devices interface 308 is configured to transmit input data and output data between I/O devices 316 and CPU 304 via interconnect 312. System disk 306 may include one or more hard disk drives, solid state storage devices, and the like. System disk 306 is configured to store a database 318 of information associated with content servers 110, fill source(s) 130, and files 218.

System memory 314 includes a control application 317 configured to access information stored in database 318 and process the information to determine the manner in which specific files 218 will be replicated across content servers 110 included in the network infrastructure 100. Control application 317 may further be configured to receive and analyze performance characteristics associated with one or more of content servers 110 and/or endpoint devices 115. As noted above, in some embodiments, metadata associated with such visual content items, and/or user/subscriber data may be stored in database 318 rather than in files 218 stored in content servers 110.

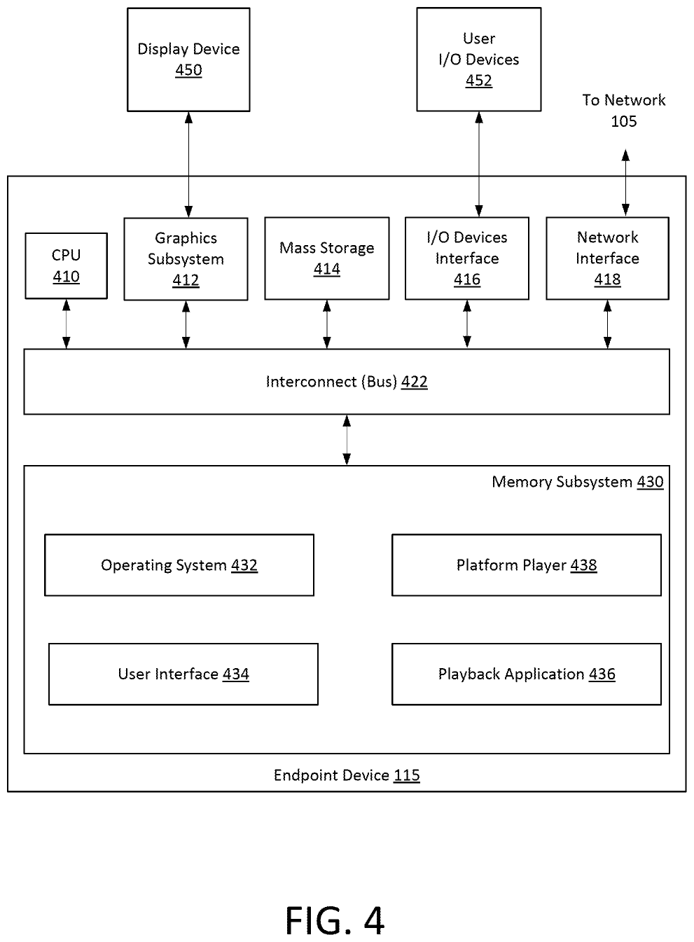

FIG. 4 is a block diagram of endpoint device 115 that may be implemented in conjunction with the network infrastructure of FIG. 1, according to various embodiments. As shown, endpoint device 115 may include, without limitation, a CPU 410, a graphics subsystem 412, an I/O devices interface 416, a mass storage unit 414, a network interface 418, an interconnect 422, and a memory subsystem 430.

In some embodiments, CPU 410 is configured to retrieve and execute programming instructions stored in memory subsystem 430. Similarly, CPU 410 is configured to store and retrieve application data (e.g., software libraries) residing in memory subsystem 430. Interconnect 422 is configured to facilitate transmission of data, such as programming instructions and application data, between CPU 410, graphics subsystem 412, I/O devices interface 416, mass storage unit 414, network interface 418, and memory subsystem 430.

In some embodiments, graphics subsystem 412 is configured to generate frames of video data and transmit the frames of video data to display device 450. In some embodiments, graphics subsystem 412 may be integrated into an integrated circuit, along with CPU 410. Display device 450 may comprise any technically feasible means for generating an image for display. For example, display device 450 may be fabricated using liquid crystal display (LCD) technology, cathode-ray technology, and light-emitting diode (LED) display technology. I/O devices interface 416 is configured to receive input data from user I/O devices 452 and transmit the input data to CPU 410 via interconnect 422. For example, user I/O devices 452 may include one or more buttons, a keyboard, and/or a mouse or other pointing device. I/O devices interface 416 also includes an audio output unit configured to generate an electrical audio output signal. User I/O devices 452 includes a speaker configured to generate an acoustic output in response to the electrical audio output signal. In alternative embodiments, display device 450 may include the speaker. Examples of suitable devices known in the art that can display video frames and generate an acoustic output include televisions, smartphones, smartwatches, electronic tablets, and the like.

A mass storage unit 414, such as a hard disk drive or flash memory storage drive, is configured to store non-volatile data. Network interface 418 is configured to transmit and receive packets of data via network 105. In some embodiments, network interface 418 is configured to communicate using the well-known Ethernet standard. Network interface 418 is coupled to CPU 410 via interconnect 422.

In some embodiments, memory subsystem 430 includes programming instructions and application data that include an operating system 432, a user interface 434, a playback application 436, and a platform player 438. Operating system 432 performs system management functions such as managing hardware devices including network interface 418, mass storage unit 414, I/O devices interface 416, and graphics subsystem 412. Operating system 432 also provides process and memory management models for user interface 434, playback application 436, and/or platform player 438. User interface 434, such as a window and object metaphor, provides a mechanism for user interaction with endpoint device 115. Persons skilled in the art will recognize the various operating systems and user interfaces that are well-known in the art and suitable for incorporation into endpoint device 115.

In some embodiments, playback application 436 is configured to request and receive content from content server 110 via network interface 418. Further, playback application 436 is configured to interpret the content and present the content via display device 450 and/or user I/O devices 452. In so doing, playback application 436 may generate frames of video data based on the received content and then transmit those frames of video data to platform player 438. In response, platform player 438 causes display device 450 to output the frames of video data for playback of the content on endpoint device 115. In one embodiment, platform player 438 is included in operating system 432.

### Techniques for Analyzing Uncertainty of Predictive Models

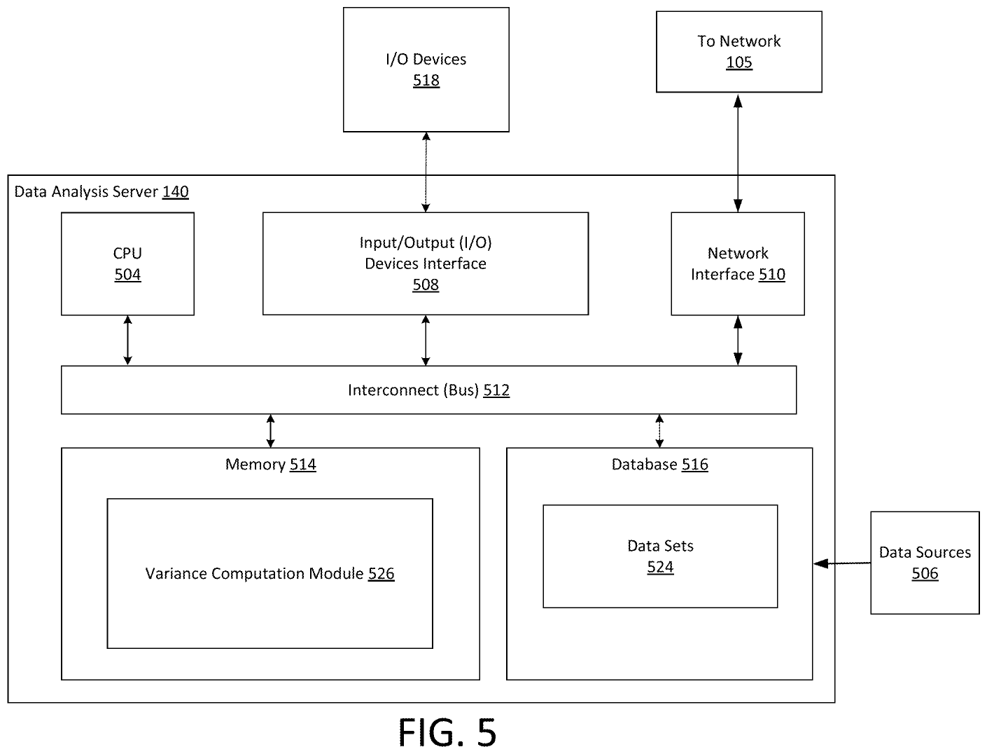

FIG. 5 is a block diagram of the data analysis server 140 that may be implemented in conjunction with the network infrastructure 100 of FIG. 1, according to various embodiments. As shown, the data analysis server 140 includes, without limitation, a central processing unit (CPU) 504, an input/output (I/O) devices interface 508, a network interface 510, an interconnect 512, a system memory 514, and a database 516. The system memory 514 includes a variance computation module 526. The database 516 includes data sets 524.

The CPU 504, I/O device interface 508, network interface 510, interconnect 512, and I/O devices 518 perform substantially similarly to the CPU 304, the input/output (I/O) devices interface 308, the network interface 310, the interconnect 312, and the I/O devices 318.

The database 516 stores information associated with the content servers 110, the fill source(s) 130, and the files 218. The database 516 may include one or more hard disk drives, solid state storage devices, and the like. In various embodiments, the database 516 stores one or more data sets 524 generated by one or more data sources 506. The data sources 506 may be included in the content servers 110, the fill source(s) 130, or any other component of network infrastructure 100.

A data set 524 may be representative of data generated via one more data gathering experiment flows, an algorithm, or a machine learning model that processes input data to generate an output dataset. A machine learning model is a pre-trained model that is used to predict or quantify a given value or a set of values. For example, a machine learning model may be used to predict one or more characteristics of users of endpoint devices 115, predict one or more operational parameters of the content servers 110, identify a set of content items to recommend to a given user of an endpoint device 115 in a user-session, identify a set of content items to make available via the content servers 110, etc. A machine learning model may include one or more recurrent neural networks (RNNs), convolutional neural networks (CNNs), deep neural networks (DNNs), deep convolutional networks (DCNs), residual neural networks (ResNets), graph neural networks, autoencoders, transformer neural networks, deep stereo geometry networks (DSGNs), stereo R-CNNs, and/or other types of artificial neural networks or components of artificial neural networks. Machine learning model may also, or instead, include a regression model, support vector machine, decision tree, random forest, gradient-boosted tree, naive Bayes classifier, Bayesian network, Hidden Markov model (HMM), hierarchical model, ensemble model, clustering technique, and/or another type of machine learning model that does not utilize artificial neural network components.

The system memory 514 includes a variance computation module 526 that processes a data set 524 to generate an uncertainty metric that is associated with the data set. In particular, the variance computation module 526 computes the variance of the data set generated by a data source 506, where the variance is a representation of the uncertainty. For data sources 506 that are machine learning models, the variance of a data set generated by the data source 506 represents the change in prediction accuracy of the data source 506 when trained on different data sets.

The uncertainty metric can be used to perform further operations related to the data source 506 that generated the data set 524. The further operations could include modifying an output of the data source 506 based on the uncertainty metric, modifying the operation of the data source 506 (such as retraining the underlying machine learning model) based on the uncertainty metric, selecting one or more outputs from multiple outputs generated by the data source 506 based on the uncertainty metric, etc. In one embodiment, the data source 506 generates recommendations for which content to present on an endpoint device 115, and the uncertainty metric is used to select one or more of the recommendations.

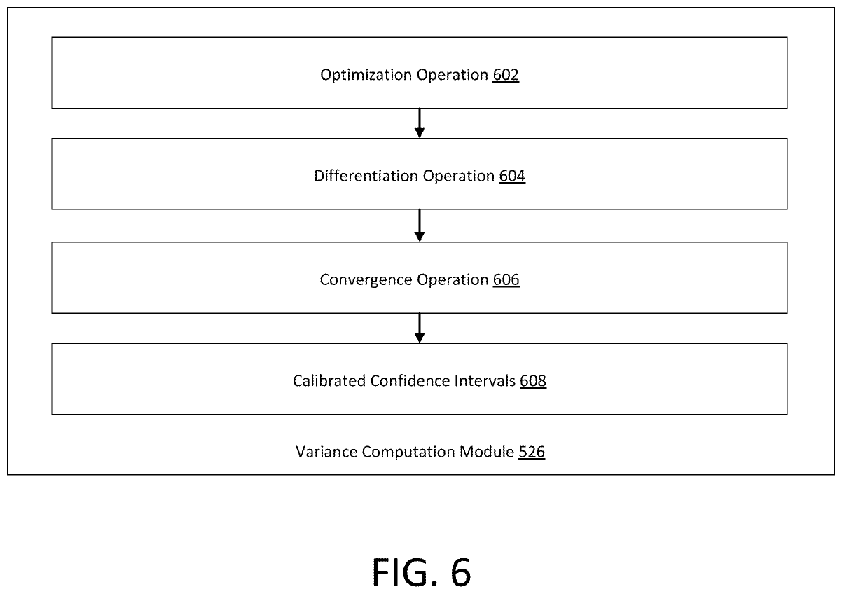

FIG. 6 is a more detailed illustration of the variance computation module 526 of FIG. 5, according to various embodiments. The variance computation module 526 implements an optimization operation 602, a differentiation operation 604, and a convergence operation 606 from which calibrated confidence intervals 608 are generated. Each of these operations are described in detail below.

The variance computation module 526 retrieves an input data set 524 from the database 516. The input data set is a collection of random samples, which are independent of each other and where each item has the same, or substantially the same, probability distribution (i.e., the data set is identically distributed). Such an input data set may include past viewed content, search history, or demographic information. The input data set 524 may be generated by a data source 506. As discussed above, the data source 506 that generates the input data set 524 may be included in the content servers 110, the fill source(s) 130, or any other component of network infrastructure 100.

In various embodiments, the input data set 524 has a probability distribution that can be represented by the density function f(z, θ), where θ is the set of parameters that determines the distribution. The set of parameters includes the mean and the variance of the data set 524.

In order to compute the variance of a given data set 524, the variance computation module 526 implements an optimization operation 602. The optimization operation 602 determines the values of the parameters θ of the data set 524 that maximize the joint probability of the observed data. More specifically, optimization operation 602 determines the set of parameters that maximizes the log-likelihood with an added regularization term. In various embodiments, the optimization operation 602 is represented by the following:

$$( λ ; ψ ) ∈ arg {max}_{θ ∈ Θ} {\sum }_{i = 1}^{n} log f ( {Z}_{i} ; θ ) + λ ψ ( θ )$$

The regularization term is λψ is referred to as the regularization coefficient, and ψ is a continuously differentiable function. In various embodiments, λ is a non-negative constant. [symbol] is the parameter that maximizes the likelihood function called the maximum likelihood estimate.

The variance computation module 526 further implements the differentiation operation 604 to generate the variance. In one embodiment, the differentiation operation computes the derivative [symbol] (λ)=ψ( [symbol] (λ;ψ)) with respect to the regularization coefficient λ. In such an embodiment, operation 604 is represented by the following:

$$= \frac{\partial }{\partial λ} ( λ ) {\vert}_{λ = 0} .$$

In other embodiments, the differentiation operation 604 implements a derivative approximator represented by the following:

$$= \frac{1}{{λ}_{n}} ( ( λ ) - ) .$$

In various embodiments, λₙ a positive constant. The above equation represents the forward finite difference formula, which is a numerical differentiation method used to estimate the derivative.

Provided that ψ(θ) is continuously differentiable, the optional convergence operation 606 indicates that the estimated variance [symbol] , the variance metric, converges in probability to the true estimated variance V₀. Moreover, for ψ(θ) three times continuously differentiable, the optional convergence operation 606 indicates that the estimated variance [symbol] converges in probability to the true asymptotic variance V₀.

A consequence of convergence is the construction of standard errors \hat{σ} and calibrated β confidence intervals 608. Standards errors are represented by the following:

$$\\ \hat{σ} \approx \frac{σ}{\sqrt{n}}$$

where σ is the sample standard deviation and n is the number of samples. Standard errors serve as an estimate of the population mean and are used in the construction of calibrated β confidence intervals 608, which are represented by the following:

$$[ \hat{ψ} \pm {Φ}^{- 1} ( ( 1 + β ) / 2 ) \sqrt{} ]$$

In various embodiments, a given data source 506 may be a machine learning model. The machine learning model is provided with an input, which is processed by the machine learning model to generate an output. As discussed above, machine learning models are subject to uncertainty due to irreducible randomness (aleatoric uncertainty) or insufficient training data (epistemic uncertainty). In particular, a machine learning model is fitted to training data and the training process determines the parameters of the model. Thus, the accuracy of the predictions of a trained machine learning model depends on the training data used. As a result, uncertainty quantification is needed to determine when a model is reliable and whether to have confidence in the predictions generated by the model given inputs different from the training data. Examples include least-squares regression, binary classification with cross-entropy loss, and Poisson regression, all with possible complex and nonlinear predictors.

The operations described above in conjunction with the variance computation module 526 can be applied in the context of deep learning and neural networks to quantify uncertainty. As an example, a given data source 506 may be a feed-forward neural network with L layers and training data {xᵢ,yᵢ}ᵢ₌₁ⁿ. The parameter vector of the network is represented by θϵ [symbol] ^{P}, where P is the number of weights and biases of the network. When training the neural network, \hat{θ}ϵ [symbol] ^{P} is the parameter vector that minimizes the cost function C(θ). ŷ denotes the output of the network after training. For an arbitrary input x₀, a prediction for x₀ is denoted by [symbol] =ƒ(x₀,\hat{θ}).

The variance computation module 526 is used to approximate the uncertainty associated with the prediction of x₀. The variance computation module 526 infinitesimally regularizes the training loss of the neural network to automatically assess the downstream uncertainty. This change in the evaluation due to regularization is consistent with the asymptotic variance of the evaluation estimator, even when the infinitesimal change is approximated by the finite difference. Thus, the variance computation module 526 provides a reliable quantification of uncertainty and allows for the construction of calibrated confidence intervals at a considerable computation savings relative to prior methods.

In various embodiments, the confidence intervals generated by the variance computation module 526 can be used to perform one or more downstream actions. For example, the confidence intervals may represent the prediction confidence of a machine learning model trained to predict the likelihood of a given user consuming the content items in a content library. In such a scenario, the confidence interval is used to determine which of the content items to recommend to a user. As another example, the confidence intervals may represent the prediction confidence of a machine learning model used to predict feature engagement with one or more features of a given content. In such a scenario, the confidence interval is used to determine which of the features to include in the content or how to include the features in the content. As another example, the confidence intervals may represent the prediction confidence of a machine learning model for various categories of input data. In such a scenario, the confidence intervals are used to determine the categories of data where the model is underperforming. This information may be used to retrain the model (using additional training data, for example) to address the underperformance.

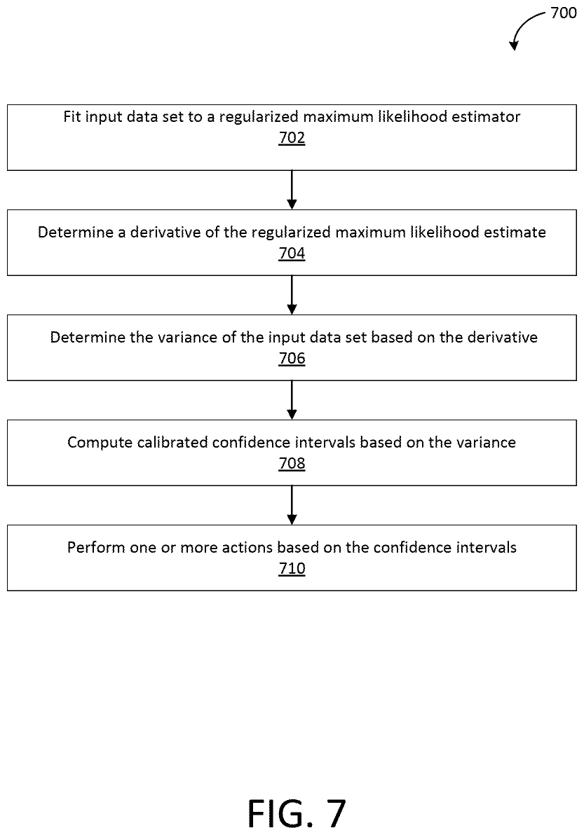

FIG. 7 is a flow diagram of method steps for determining content recommendations using the variance computation module from FIG. 5, according to various embodiments. Although the method steps are described in conjunction with the systems of FIGS. 1-6, persons skilled in the art will understand that any system configured to perform the method steps, in any order, is within the scope of the present invention.

As shown, method 700 begins at step 702, where the variance computation module 526 fits an input data set to a maximum likelihood estimator having a regularization term. This determines the set of parameters that maximizes the log-likelihood with an added regularization term. In various embodiments, the maximum likelihood estimator having a regularization term is represented by the following:

$$( λ ; ψ ) ∈ arg {max}_{θ ∈ Θ} {\sum }_{i = 1}^{n} log f ( {Z}_{i} ; θ ) + λ ψ ( θ )$$

The regularization term is λψ, referred to as the regularization coefficient, and ψ is a continuously differentiable function.

At step 704, the variance computation module 526 determines a derivative of the maximum likelihood estimate with respect to λ. At step 706, the variance computation module 526 determines the variance of the input dataset based on the derivative.

At step 708, the variance computation module 526 computes confidence intervals associated with the input data set based on the variance. At step 710, the variance computation module 526 or another downstream component of system 100 performs one or more actions based on the confidence intervals.

At least one technological advantage of the disclosed techniques relative to the prior art is that the variance of a data set can be computed in a computationally efficient manner relative to prior art techniques. This cost saving enables variance to be computed in deep learning and other machine learning domains, where the variance computation would otherwise be prohibitive.
1. In some embodiments, a computer-implemented method comprises receiving a data set generated by a machine learning model, wherein the data set comprises a plurality of data samples that are independent of each other, performing two or more fitting operations to fit the data set to regularized maximum likelihood estimators (MLEs), determining a variance associated with the data set based on a derivative associated with the regularized MLEs, and performing one or more operations associated with the machine learning model based on the variance.
2. The method of clause 1, wherein the variance represents a change in prediction accuracy of the machine learning model when trained on different data sets.
3. The method of clause 1 or clause 2, wherein the two or more fitting operations infinitesimally regularizes the training loss of the neural network.
4. The method of any of clauses 1-3, wherein a regularization term is added to the MLEs.
5. The method of any of clauses 1-4, wherein the regularization term is continuously derivable.
6. The method of any of clauses 1-5, further comprising determining one or more confidence intervals associated with the machine learning model based on the variance.
7. The method of any of clauses 1-6, wherein the one or more operations associated with the machine learning model comprise training the machine learning model based on additional training data determined based on the variance.
8. The method of any of clauses 1-7, wherein the one or more operations associated with the machine learning model comprise selecting one or more outputs from a plurality of outputs generated by the machine learning model based on the variance.
9. The method of any of clauses 1-8, wherein the one or more operations associated with the machine learning model comprise modifying an output of the machine learning model based on the variance.
10. In some embodiments, one or more non-transitory computer-readable media store instructions that, when executed by one or more processors, cause the one or more processors to perform the steps of receiving a data set generated by a machine learning model, wherein the data set comprises a plurality of data samples that are independent of each other, performing two or more fitting operations to fit the data set to regularized maximum likelihood estimators (MLEs), determining a variance associated with the data set based on a derivative associated with the regularized MLEs, and performing one or more operations associated with the machine learning model based on the variance.
11. The one or more non-transitory computer-readable media of clause 10, wherein the variance represents a change in prediction accuracy of the machine learning model when trained on different data sets.
12. The one or more non-transitory computer-readable media of clauses 10 or 11, wherein the two or more fitting operations infinitesimally regularizes the training loss of the neural network
13. The one or more non-transitory computer-readable media of any of clauses 10-12, wherein a regularization term is added to the MLEs.
14. The one or more non-transitory computer-readable media of any of clauses 10-13, wherein the regularization term is continuously derivable.
15. The one or more non-transitory computer-readable media of any of clauses 10-14, further comprising determining one or more confidence intervals associated with the machine learning model based on the variance.
16. The one or more non-transitory computer-readable media of any of clauses 10-15, wherein the one or more operations associated with the machine learning model comprise training the machine learning model based on additional training data determined based on the variance.
17. The one or more non-transitory computer-readable media of any of clauses 10-16, wherein the one or more operations associated with the machine learning model comprise selecting one or more outputs from a plurality of outputs generated by the machine learning model based on the variance.
18. The one or more non-transitory computer-readable media of any of clauses 10-17, wherein the one or more operations associated with the machine learning model comprise modifying an output of the machine learning model based on the variance.
19. In some embodiments, a computer system, comprises one or more memories storing instructions, and one or more processors for executing the instructions to: receive a data set generated by a machine learning model, wherein the data set comprises a plurality of data samples that are independent of each other, performing two or more fitting operations to fit the data set to regularized maximum likelihood estimators (MLEs), determining a variance associated with the data set based on a derivative associated with the regularized MLEs, and performing one or more operations associated with the machine learning model based on the variance.
20. The computer system of clause 19, wherein the variance represents a change in prediction accuracy of the machine learning when trained on different data sets.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method, comprising:
receiving a data set generated by a machine learning model, wherein the data set comprises a plurality of data samples that are independent of each other;
performing two or more fitting operations to fit the data set to regularized maximum likelihood estimators (MLEs);
determining a variance associated with the data set based on a derivative associated with the regularized MLEs; and
performing one or more operations associated with the machine learning model based on the variance.

2. The method of claim 1, wherein the variance represents a change in prediction accuracy of the machine learning model when trained on different data sets.

3. The method of claim 1, wherein the two or more fitting operations infinitesimally regularizes the training loss of the neural network.

4. The method of claim 1, wherein a regularization term is added to the MLEs.

5. The method of claim 1, wherein the regularization term is continuously derivable.

6. The method of claim 1, further comprising determining one or more confidence intervals associated with the machine learning model based on the variance.

7. The method of claim 1, wherein the one or more operations associated with the machine learning model comprise training the machine learning model based on additional training data determined based on the variance.

8. The method of claim 1, wherein the one or more operations associated with the machine learning model comprise selecting one or more outputs from a plurality of outputs generated by the machine learning model based on the variance.

9. The method of claim 1, wherein the one or more operations associated with the machine learning model comprise modifying an output of the machine learning model based on the variance.

10. One or more non-transitory computer-readable media storing instructions that, when executed by one or more processors, cause the one or more processors to perform the steps of:
receiving a data set generated by a machine learning model, wherein the data set comprises a plurality of data samples that are independent of each other;
performing two or more fitting operations to fit the data set to regularized maximum likelihood estimators (MLEs);
determining a variance associated with the data set based on a derivative associated with the regularized MLEs; and
performing one or more operations associated with the machine learning model based on the variance.

11. The one or more non-transitory computer-readable media of claim 10, wherein the variance represents a change in prediction accuracy of the machine learning model when trained on different data sets.

12. The one or more non-transitory computer-readable media of claim 10, wherein the two or more fitting operations infinitesimally regularizes the training loss of the neural network.

13. The one or more non-transitory computer-readable media of claim 10, wherein a regularization term is added to the MLEs.

14. The one or more non-transitory computer-readable media of claim 10, wherein the regularization term is continuously derivable.

15. The one or more non-transitory computer-readable media of claim 10, further comprising determining one or more confidence intervals associated with the machine learning model based on the variance.

16. The one or more non-transitory computer-readable media of claim 10, wherein the one or more operations associated with the machine learning model comprise training the machine learning model based on additional training data determined based on the variance.

17. The one or more non-transitory computer-readable media of claim 10, wherein the one or more operations associated with the machine learning model comprise selecting one or more outputs from a plurality of outputs generated by the machine learning model based on the variance.

18. The one or more non-transitory computer-readable media of claim 10, wherein the one or more operations associated with the machine learning model comprise modifying an output of the machine learning model based on the variance.

19. A computer system, comprising:
one or more memories storing instructions; and
one or more processors for executing the instructions to:
receive a data set generated by a machine learning model, wherein the data set comprises a plurality of data samples that are independent of each other;
performing two or more fitting operations to fit the data set to regularized maximum likelihood estimators (MLEs);
determining a variance associated with the data set based on a derivative associated with the regularized MLEs; and
performing one or more operations associated with the machine learning model based on the variance.

20. The computer system of claim 19, wherein the variance represents a change in prediction accuracy of the machine learning when trained on different data sets.
